(19) United States
(12) Patent Application Publication
(10) Pub. No.: US 2026/0219760 A1
(43) Pub. Date: Jul. 30, 2026

(54) DUAL PANEL VISUAL MAPPING OF LOGICAL AND PHYSICAL NETWORK TOPOLOGIES

(71) Applicant: Cisco Technology, Inc., San Jose, CA (US)

(72) Inventors: Fiona HALL-ZAZUETA, San Jose, CA (US); Swapna ANANDAN, Fremont, CA (US); Elango GANESAN, Portola Valley, CA (US); Michael FREED, Pleasanton, CA (US); Ruben Erick ESCOLERO, San Francisco, CA (US)

(21) Appl. No.: 19/037,116

(22) Filed: Jan. 25, 2025

(51) Int. Cl. G06F 3/04815; G06F 3/04842

(52) U.S. Cl. CPC G06F 3/04815; G06F 3/04842

(57) ABSTRACT

In one embodiment, a visualization process herein: provides a graphical user interface that displays two portions, one of the two portions displaying a physical network topology of a computer network and another of the two portions displaying a logical grouping policy applied within the computer network; detects a user selection of one or more first visual representation components on a first portion of the two portions; maps the one or more first visual representation components on the first portion to one or more second visual representation components on a second portion of the two portions based on how the logical grouping policy relates to the physical network topology; and highlights, on the graphical user interface in response to the user selection, the one or more first visual representation components on the first portion and the one or more second visual representation components on the second portion.

### TECHNICAL FIELD

The present disclosure relates generally to computer networks, and, more particularly, to dual panel visual mapping of logical and physical network topologies.

### BACKGROUND

Physical network topologies relate to the actual physical layout of devices in a computer network and their physical connections. A logical network topology, or more particularly “process based segmentation” (prevalent in manufacturing), on the other hand, refers to how devices are organized functionally within a network, and how data flows logically within the network as an overlay on top of the underlying physical layout.

Moreover, a logical policy, more particularly a “Process Control Policy”, in the context of network management, refers to a set of rules or guidelines that dictate how a network and its resources are organized, managed, and accessed. Process Control Policies are applicable for Industrial Control Systems which include supervisory control, data acquisition (SCADA) systems, and control systems such as programmable logic controllers (PLCs) which operate on critical infrastructure. These require controlled connectivity policies, unauthorized access/control capabilities, safety control policies (including restricting logical processes), protection from exploitation, and the ability to track/monitor and audit. Based on the need for in-depth defensive strategies, these Industrial Control Systems require the industrial processes to be controlled with logical separations, including a multi-layer network topology and associated critical communication.

Notably, these policies are not tied to the physical layout of the network (like the placement of cables or hardware) but rather to how the network is used and controlled. That is, logical policies are designed to control and manage the behavior of a network, such as data flow, access controls, resource allocation, security measures, and so on, dictating how the network should operate under various conditions. In other words, logical policies are a framework of rules that guide the operation, security, and management of a network, focusing on how the network's resources are used and accessed rather than on the physical configuration of the network hardware.

User interfaces in network management tools play a crucial role in illustrating both the physical layout and the logical data paths of a network, helping administrators to effectively manage and troubleshoot the network. However, mapping physical network topologies to logical policies and groupings can be challenging for several reasons. For instance, once logical policies are defined, determining which devices in the network correspond to (e.g., implement, are affected by, or are otherwise involved in) those policies can be a daunting process, especially in large, complex networks. Moreover, maintaining consistency between the physical setup and the logical policies is challenging, particularly as networks evolve and new devices or policies are added, or where configurations are changed.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example architecture for dual panel visual mapping of logical and physical network topologies;

FIG. 4 illustrates an example network topology view of an illustrative dual-panel user interface herein for visual mapping of logical groupings and physical network topology;

FIGS. 5-12 illustrate example views of the illustrative dual-panel user interface showcasing associated features and operations according to the techniques herein;

FIGS. 13-15 illustrate an example user interface according to a group-based policy matrix view with a physical topology viewer;

FIG. 16 illustrates an example of an organization-tree-based visualization; and

FIG. 17 illustrates an example procedure for dual panel visual mapping of logical and physical network topologies.

### DESCRIPTION OF EXAMPLE EMBODIMENTS

### Overview

According to one or more embodiments of the disclosure, dual panel visual mapping of logical and physical network topologies is provided herein. In particular, in one embodiment, an illustrative method herein may comprise: providing, by a visualization process, a graphical user interface that displays two portions, one of the two portions displaying a physical network topology of a computer network and another of the two portions displaying a logical grouping policy applied within the computer network; detecting, by the visualization process, a user selection of one or more first visual representation components on a first portion of the two portions; mapping, by the visualization process, the one or more first visual representation components on the first portion to one or more second visual representation components on a second portion of the two portions based on how the logical grouping policy relates to the physical network topology; and highlighting, by the visualization process and on the graphical user interface in response to the user selection, the one or more first visual representation components on the first portion and the one or more second visual representation components on the second portion.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

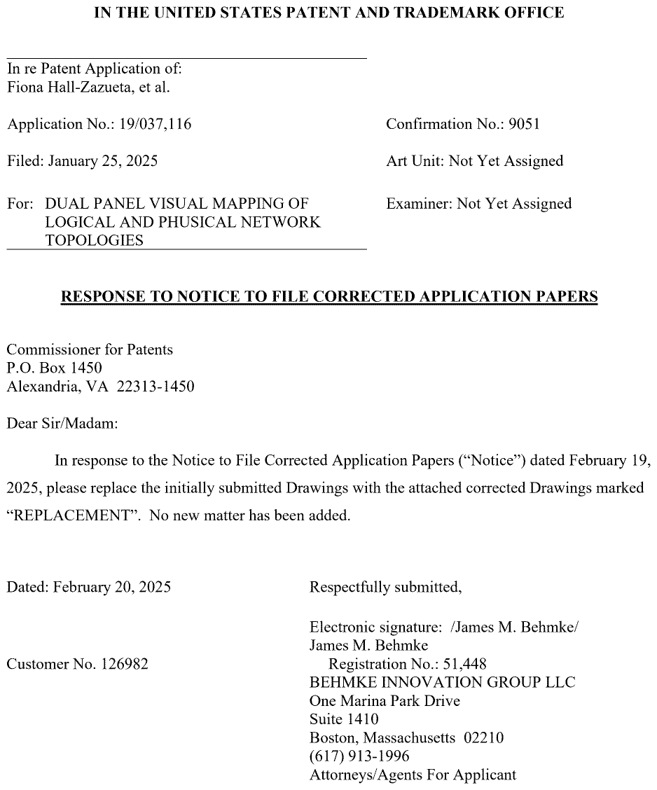

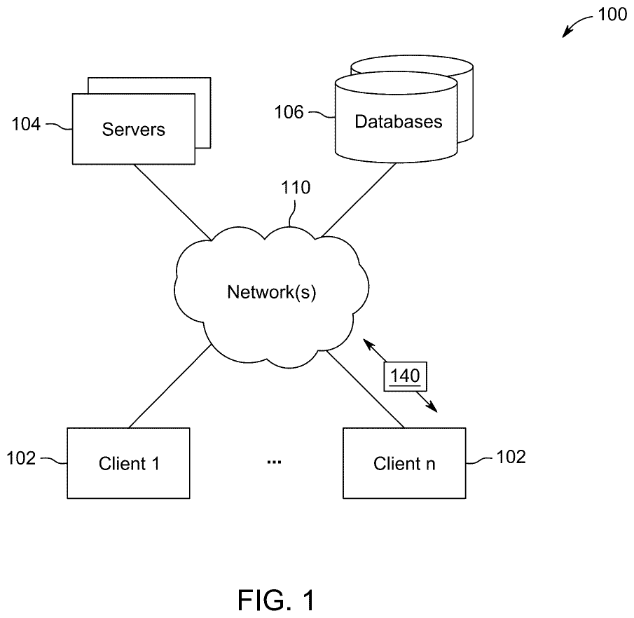

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

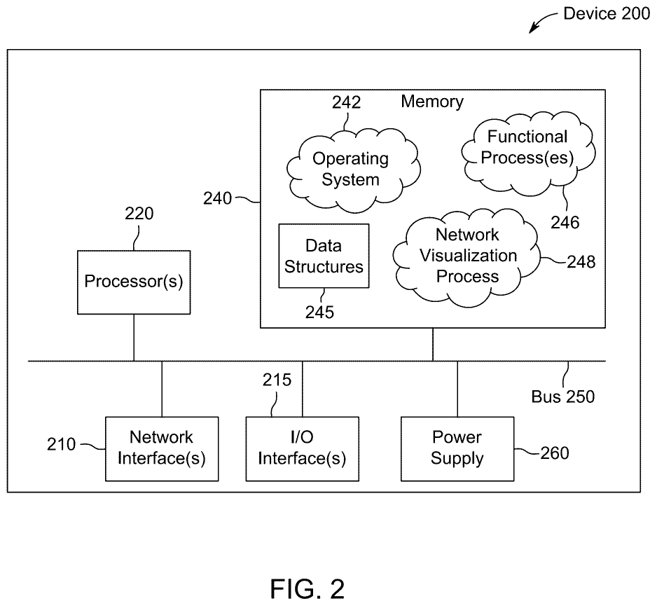

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a network visualization process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### Dual Panel Visual Mapping of Logical and Physical Network Topologies

As noted above, a logical network topology (e.g., “process based segmentation”) refers to how devices are organized functionally within a network, and how data flows logically within the network as an overlay on top of the underlying physical layout. Also, a logical policy (e.g., a “Process Control Policy”) refers to a set of rules or guidelines that dictate how a network and its resources are organized, managed, and accessed.

Moreover, these policies are not tied to the physical layout of the network (like the placement of cables or hardware) but rather to how the network is used and controlled, typically involving the creation of groupings, zones, and sub-zones based on specific policies and their enforcement. That is, logical policies are designed to control and manage the behavior of a network, such as data flow, access controls, resource allocation, security measures, and so on, dictating how the network should operate under various conditions. Examples include access control policies, security policies, Quality of Service (QoS) policies, data routing policies, segmentation policies, and so on. In other words, logical policies are a framework of rules that guide the operation, security, and management of a network, focusing on how the network's resources are used and accessed rather than on the physical configuration of the network hardware.

Note, too, that overall design considerations for Industrial Control Systems are decided based on controlled-timing, reliability, safety, geographical distribution, and centralized/distributed control requirements. The underlying physical network is used to implement these design requirements based on the process control needs. These could be driven by regulatory requirements and best practices based on different systems such as assembly lines, power grid, or oil pipelines. Being able to adequately manage and monitor the interrelations between the control policies and the physical network is a crucial task for administrators.

As also noted above, user interfaces in network management tools play a crucial role in illustrating both the physical layout and the logical data paths of a network, helping administrators to effectively manage and troubleshoot the network. However, mapping physical network topologies to logical policies and groupings can be challenging for several reasons. For instance, once logical policies are defined, determining which devices in the network correspond to (e.g., implement, are affected by, or are otherwise involved in) those policies can be a daunting process, especially in large, complex networks. Moreover, maintaining consistency between the physical setup and the logical policies is challenging, particularly as networks evolve and new devices or policies are added, or where configurations are changed. Further, suitable visualizations today of the correlations between physical network topologies and the associated logical policies simply do not exist today.

The techniques herein, therefore, are directed to providing a dual panel visual mapping of logical and physical network topologies. In particular, the techniques herein provide a graphical user interface that displays side-by-side portions, one of the two portions displaying a physical network topology of a computer network and another of the two portions displaying a logical grouping policy applied within the computer network. An additional view may present the logical grouping policy, showcasing how the network's resources are organized and managed according to security and operational policies, such as those defined by a Group-Based Policy (GBP).

The system's intelligent design allows for seamless interaction between these two views. As described in greater detail below, when a user selects an element within the logical grouping policy view, the system herein dynamically highlights all corresponding physical assets represented in the physical topology view. Also, the techniques herein are a bi-directional highlighting mechanism, ensuring that any selection made on the logical side is accurately reflected on the physical side, and vice versa. That is, based on user selection of icons on one side/portion, the system herein highlights that selection as well as the corresponding icons of the other side/portion based on mapping the underlying components. By selecting (e.g., clicking on) a logical grouping brings into focus all the network devices and endpoints that are part of that group (i.e., all the physical assets within that grouping), while selecting a physical asset (e.g., device) on the physical topology illuminates all the logical groupings to which the device belongs (i.e., all the logical groupings in which those assets are assigned). Other features such as assigning these mappings, providing further/granular details, and view-based filtering are also described in the embodiments below.

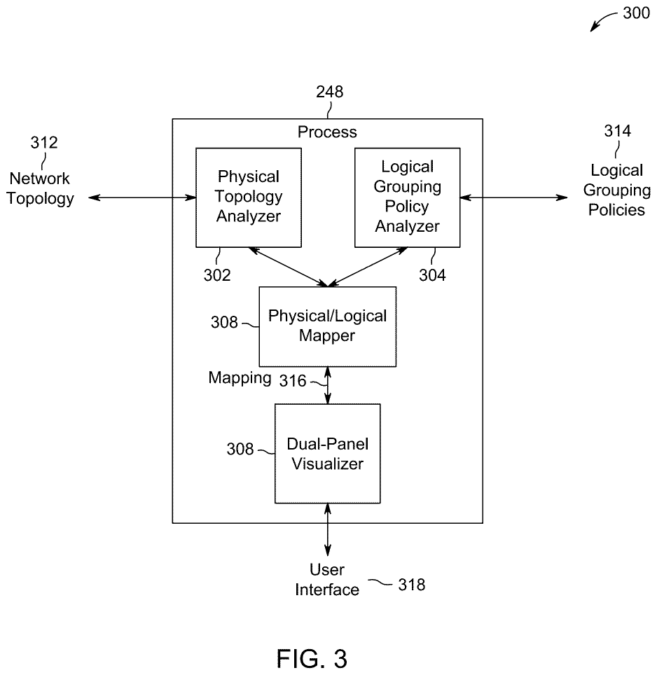

FIG. 3 illustrates an example architecture for providing a dual panel visual mapping of logical and physical network topologies, according to various implementations. At the core of architecture 300 is network visualization process (process 248), which may include any or all of the following components: a physical topology analyzer 302, a logical grouping policy analyzer 304, a physical/logical mapper 306 in communication with each, and a dual-panel visualizer 308 in communication with the physical/logical mapper 306. Process 248 may be executed by a server, a controller, a diagnostic or administrative management device, or another suitably configured device with knowledge of, or in communication with one or more other devices with knowledge of (such as via one or more application programming interfaces (APIs), etc.), network topology 312 and logical grouping policies 314. In addition, process 248 may communicate with any number of user interfaces, such as user interface 318.

As would be appreciated, the functionalities of these components may be combined or omitted, as desired (e.g., implemented as part of process 248). In addition, these components may be implemented on a singular device or in a distributed manner, in which case the combination of executing devices can be viewed as their own singular device for purposes of executing the process 248.

According to various implementations as described in greater detail below, physical topology analyzer 302 may leverage network topology 312 to determine physical topology components of a given computer network, such as interconnectivity between certain devices, information about the interconnectivity and/or devices (e.g., type, configuration, names/identifiers, status, telemetry, and so on).

Additionally, according to various implementations as described in greater detail below, logical grouping policy analyzer 304 may obtain logical grouping policies 314, such as from various network management entities tasked with configuring such policies or discovering such policies.

According to the techniques herein, the physical/logical mapper 306 is then tasked with bi-directionally correlating the network topology 312 to the logical grouping policies 314 into mapping 316, as described in greater detail below. That is, according one or more embodiments herein, physical assets of the network topology 312 may be mapped to one or more of the logical grouping policies 314, and vice versa. The dual-panel visualizer 308 then takes this mapping 316 and prepares it for visual presentation (e.g., a dual-panel visual mapping) and interaction through user interface 318 as detailed below.

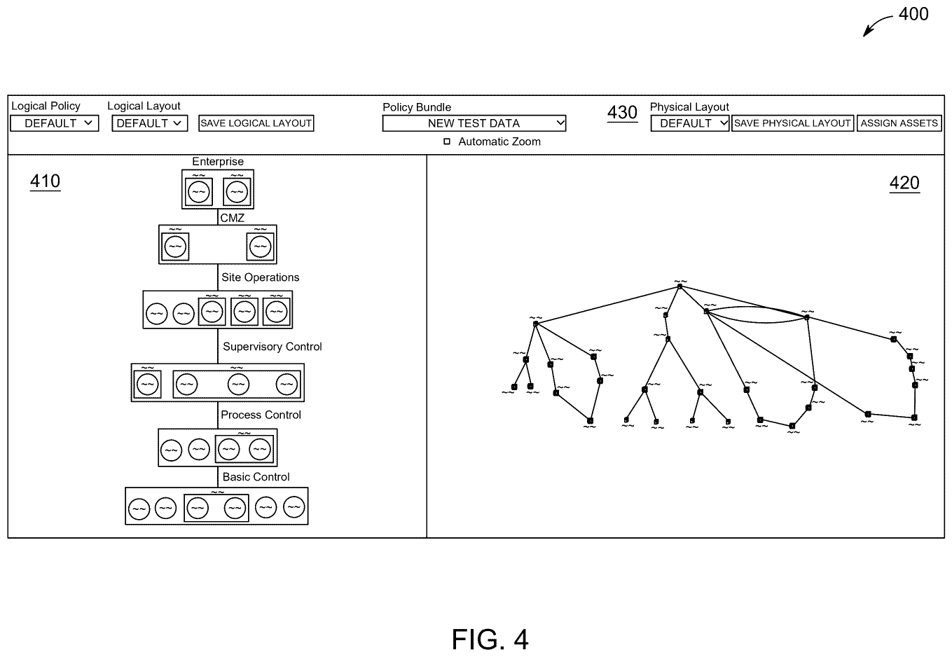

Operationally, FIG. 4 illustrates an example network topology view of the illustrative user interface herein (UI 400), with logical groupings 410 shown on the left, and the physical network topology 420 shown on the right. Note that “left” or “right” placements are for illustrative purposes only, and any arrangement may be made, including vertical stacking (top and bottom). Each view is scrollable and zoomable, and each entity (zone, subzone, asset-group, or network device) may be selected to provide further insight as described herein. Also a menu bar 430 may allow for selection of various features and/or functions within UI 400, such as through selection of logical policy, logical layout, policy bundle, physical layout, as well as other action buttons such as saving logical and/or physical layouts, assigning assets, and so on, as generally described below.

Note that the control groups shown within the logical groupings (e.g., basic control, process control, supervisory control, etc.) are shown based on an example of distributed control systems corresponding to various industries such as automotive, manufacturing, oil and gas, and power-grid use cases. However, the logical and/or physical topologies may differ according to specific use cases and implementations in order to enact the operational control for discrete processes.

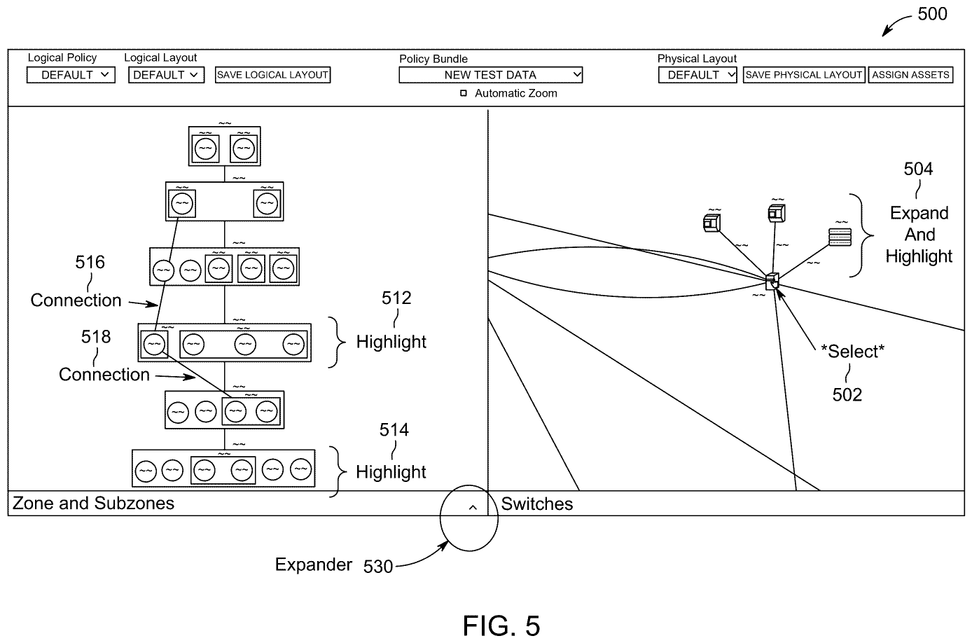

According to the techniques herein, and with reference to view 500 of FIG. 5, if an admin wants to see the assets connected to a particular switch, for example, as well as the groups that those assets are in, they may just select (e.g., click) the switch they're interested in (“select 502”), which brings up a highlighted set of assets (“expand and highlight 504”) as well as a highlighted set of groups (and zones) (“highlight 512” and “highlight 514”) that correspond to that switch and its assets. Other connections (“connection 516” and “connection 518”) based on the logical connectivity may also be displayed based on the selected node and corresponding mapping.

Note, generally, that the groups can be designed based on time-criticality, performance requirements, and so on, and having a side-by-side view can enable the admin to troubleshoot availability issues when there is an unexpected physical network outage and adversely impacting the safety and security of the control process with a clear visibility to manage the outage and implement change management and recovery.

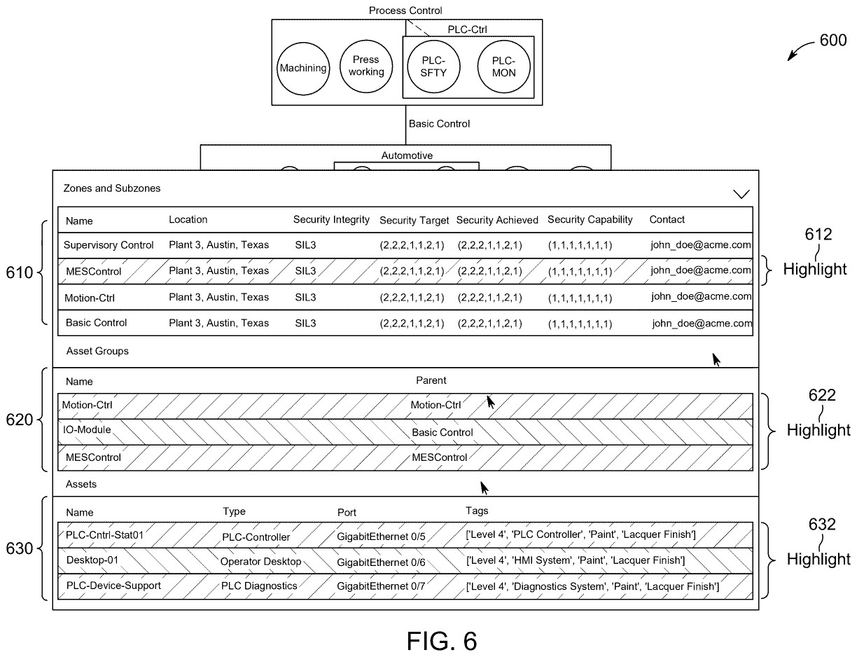

If an admin wants to know more detail about those groups and zones, they can open a panel (e.g., expander caret 530 at the bottom) to get additional available detail, as shown in view 600 of FIG. 6. In particular, zones and subzones 610 have been expanded to show further information regarding those highlighted zones and subzones (e.g., names and locations of control groups, security information, contact information, etc.). Additionally, asset groups 620 and assets 630 illustrate further information that may be viewed through the expanded information view (e.g., names and parents of asset groups, names/types/ports/tags of assets, etc.). Note, too, that details within the view 600 may also be highlighted according to their correlation to the selected asset, such as highlight 612, highlight 622, and highlight 632, as shown.

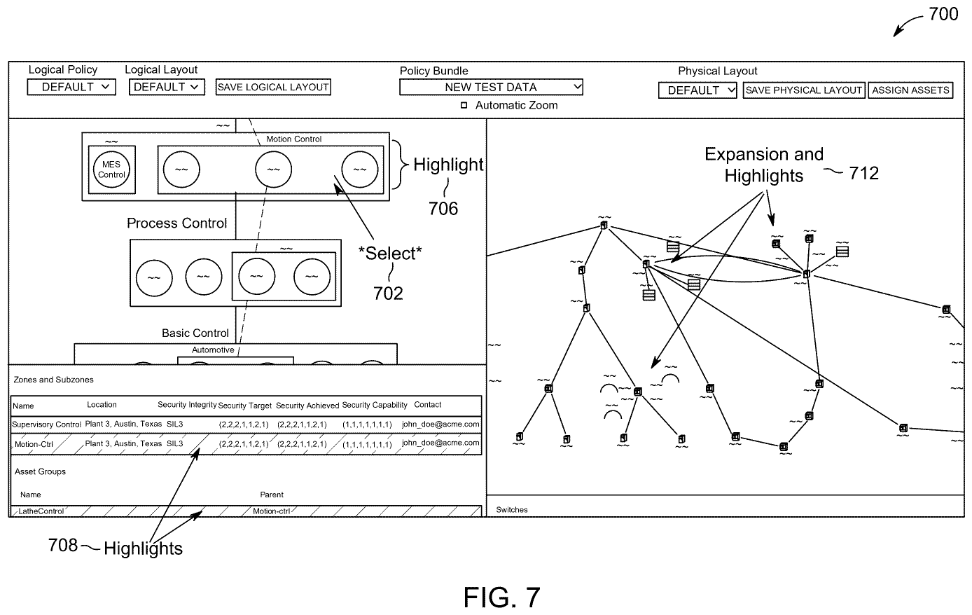

According to the bi-directionality of the techniques herein, this correlation also works in the opposite direction. For instance, with reference to view 700 of FIG. 7, if an admin wants to see all the assets and network devices associated with a specific zone (e.g., motion control), the admin can select that zone (“select 702”), which creates highlight 706 of the selected group/zone (as well as highlights 708 if the expanded detail list is still open), and then after zooming out on the network topology side (e.g., assuming a zoomed in view 500 from FIG. 5 still), they will be able to see all the network devices and their associated assets within that zone have been highlighted in the physical topology (“expansion and highlights 712”).

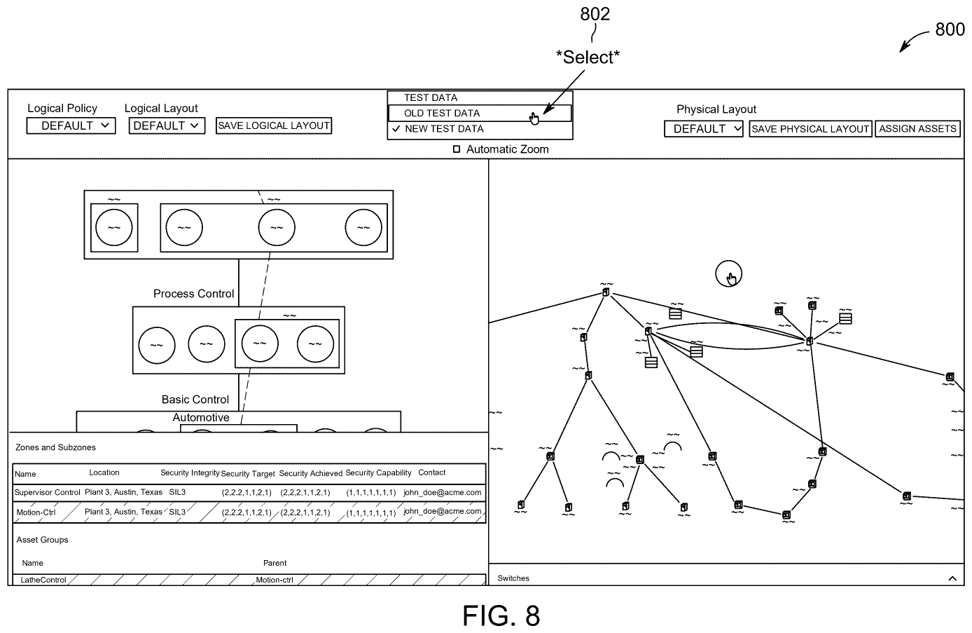

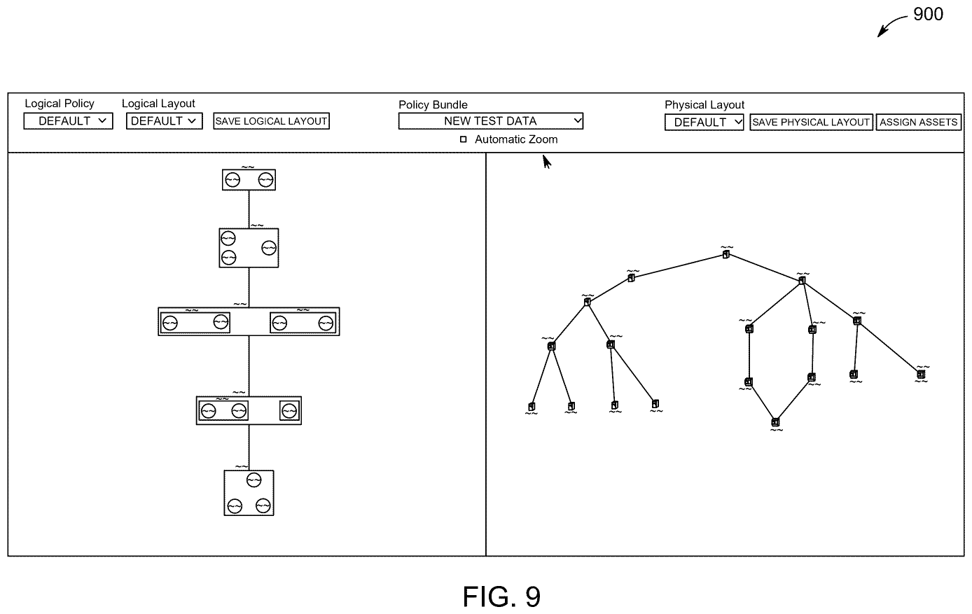

The UI tool herein also allows switching between different networks. For example, if an admin wants to see a subset of the physical network, they can switch the “policy bundle”, such as shown in view 800 of FIG. 8 (“select 802”, illustratively switching from “new test data” to “old test data”). This would allow for a change in the physical network (e.g., to see a smaller/different physical network) with a different corresponding logical grouping, such as shown in view 900 of FIG. 9. Note that selection and highlighting still works the same way as described above in this new view.

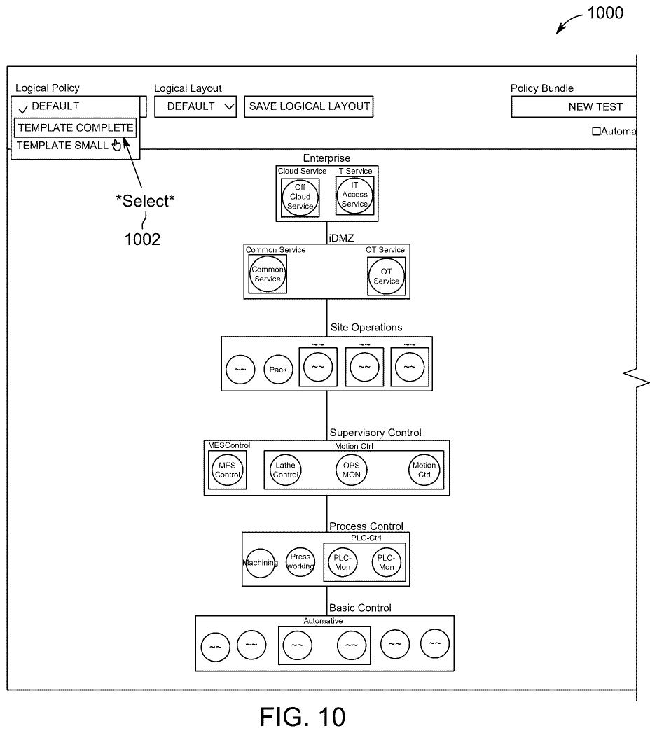

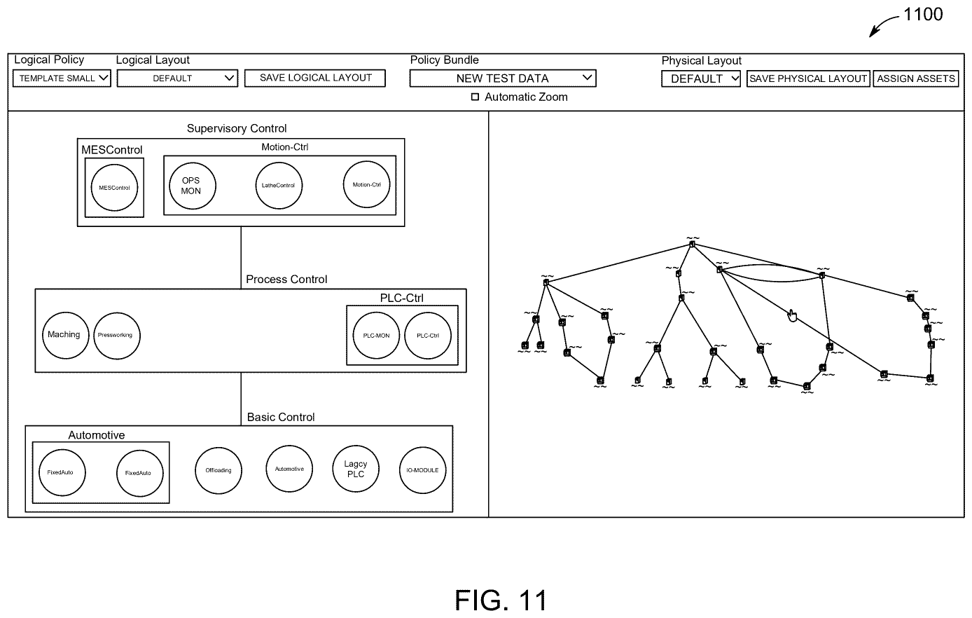

On the larger physical network, there may be different logical groupings for the same physical network. These may be a different security policy, or perhaps a logical grouping that is instead focused on the actual uses of the assets, such as on a production line. Notably, new policies and rules may be created all the time on the same underlying physical network. As such, according to the techniques herein and as shown in sub-view 1000 of FIG. 10, the admin can also switch to a different logical policy, such as shown at “select 1002” to change from a “template complete” logical policy to, for example, a “template small” policy. As shown in view 1100 of FIG. 11, now a smaller set of logical groups corresponding to the same (larger/original) physical network are shown, accordingly.

Another feature herein is asset assignment to logical groups. For instance, if a logical grouping is selected, any assigned assets will be shown. However, if assets are to be added to a grouping, the techniques provide such a mechanism. The use case for such an asset allocation to a certain group, for example, could be driven based on an updated security policy or regulatory requirements, or an upgrade of an existing hardware asset which has new capabilities/interfaces, and so on.

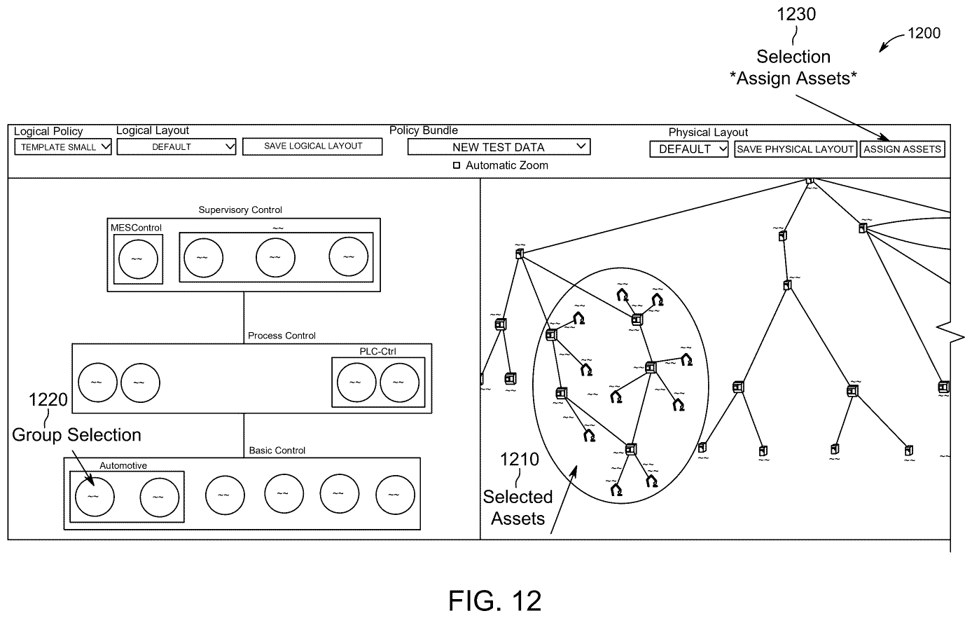

Assume, for example, and with reference to view 1200 of FIG. 12, that a logical grouping with no assets are assigned to it (e.g., basic control, automotive, “FlexAuto”, as shown), where at first, no assets would have been shown on the physical view panel. To make such an assignment, the admin may select the assets that they want to assign to a group (“selected assets 1210”), and then may select the group (e.g., using a right click, “group selection 1220”), and then may select/click “assign assets 1230” to establish the mapping, accordingly. Then, going forward, when the admin selects that group, the UI will highlight the relevant assets and the network devices they're attached to, accordingly (i.e., showing the same view as view 1200). In this manner, the logical groupings and zones may evolve, while the physical network stays generally the same until physical connections or new devices are added (or removed).

Note that other workflows (such as first selecting the group, then selecting “assign assets”, and then selecting the assets) may be used here, and the example shown is merely one possible implementation herein. Note too that similar techniques may be used herein to add assets to an existing grouping, such as by selecting the grouping, selecting “assign assets”, and then further selecting the additional assets as desired, accordingly. Still other implementations may allow for “right click” options to add assets (e.g., individually or in groups of selected assets), remove assets, and so on.

While the above description has generally maintained the same overall structure of the logical topology (grouping policies), other example use cases and configurations are also conceived herein. For instance, in accordance with one specific implementation herein, the dual panel visual mapping of logical and physical network topologies herein may be a group-based policy matrix with a physical topology viewer.

In particular, a group-based policy (GBP) matrix within security dashboards allows administrators to define and visualize the relationships between different security group tags (SGTs). This matrix makes it easier to understand and control how policies are applied between various groups on the network.

The techniques herein, therefore, can integrate a network visualization tool with these security dashboards, and enhances the capabilities of the security dashboard. For instance, the techniques herein would allow administrators to see a visual representation of the network's topology alongside the logical groupings defined in a group-based policy matrix, such that the side-by-side view can help users understand how security policies are being applied in the context of the network's physical layout.

That is, the techniques herein enable the user to navigate and visualize the group-based policy matrix with the context of the physical network topology with better insights into the security policies between different logical groups. This also helps the admin to identify the deployed policies and optimally update enforcement points based on the intermediate switches and their capabilities. This visualization can help simplify the management of complex security policies, making it easier to identify gaps or inconsistencies in policy for an operational technology (OT) user.

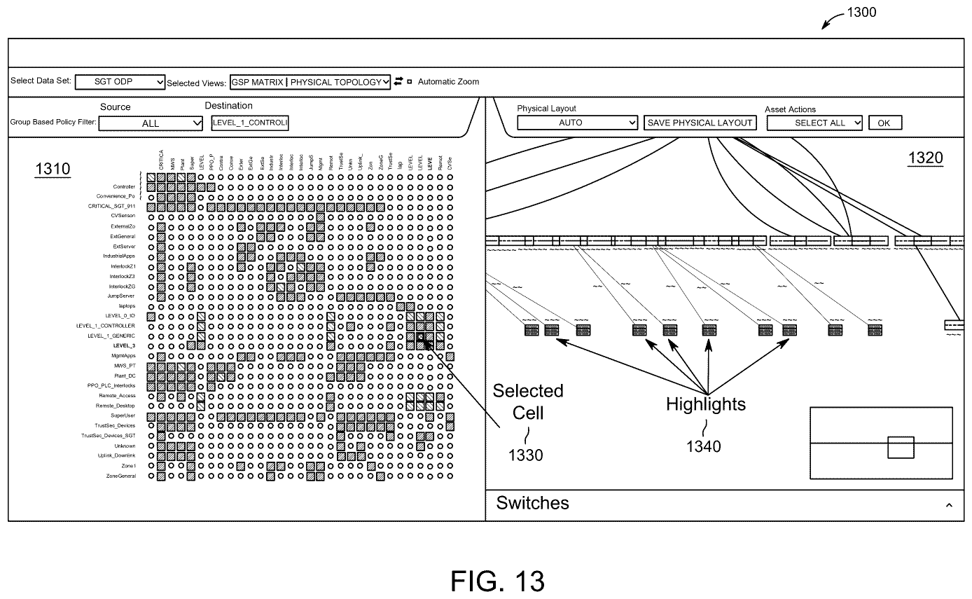

FIG. 13 illustrates an example side-by-side view (view 1300) according to the techniques herein where the logical side of the dual panel visualization corresponds to the group-based policy matrix 1310, and the other side is the network physical topology 1320. As shown, one cell in the matrix is selected (“selected cell 1330”) and all the assets which belong to the source and destination security groups are highlighted in the physical topology (“highlights 1340”). Once a cell is selected, the techniques herein automatically highlight all the network assets (such as switches, routers, endpoints, etc.) that are members of the source and destination security groups associated with that policy. This includes changing the color, border, or adding a visual indicator around the assets on the network diagram.

By highlighting the relevant assets on the physical topology, the tool herein provides a clear visual correlation between the abstract policy matrix and the actual devices on the network. This helps administrators to understand which parts of the physical infrastructure are affected by the policy defined in the selected matrix cell. This integrated approach is particularly useful for troubleshooting policy-related issues, impact analysis, and ensuring compliance. If there is a connectivity problem or a security breach, administrators can quickly see which parts of the network are involved and take appropriate action.

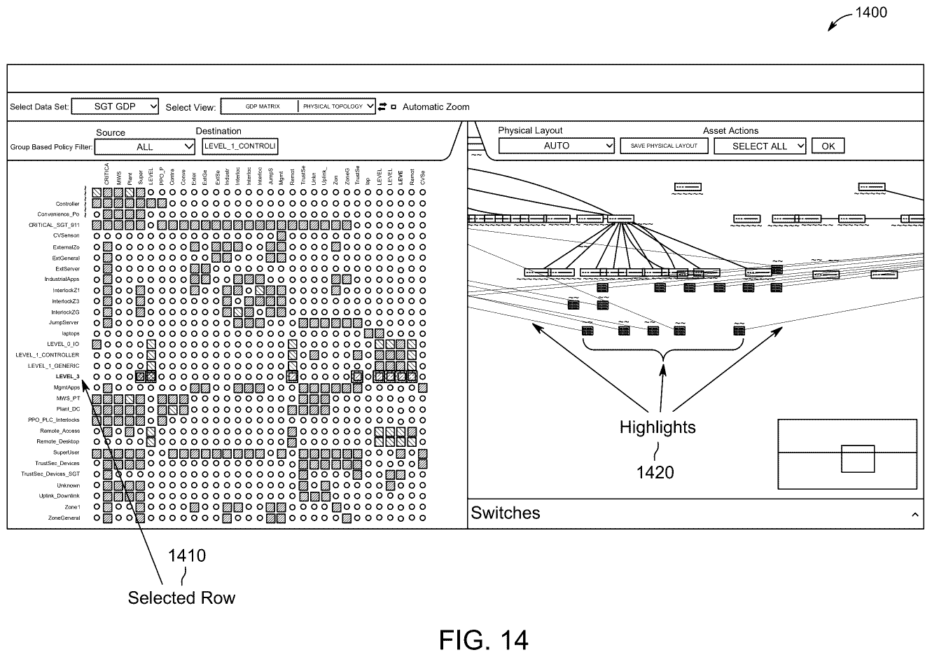

Additionally, FIG. 14 illustrates another view 1400 where a row within the matrix is selected (“selected row 1410”) highlighting all the assets (highlights 1420) that belong to an SGT (e.g., “LEVEL 3”). The techniques herein may also highlight all the physical connections from the assets, as well. This involves changing the visual representation of those devices and/or using indicators to make them stand out. This provides a comprehensive view of how traffic from the source security group can potentially flow through the network to better understand the security posture of the traffic.

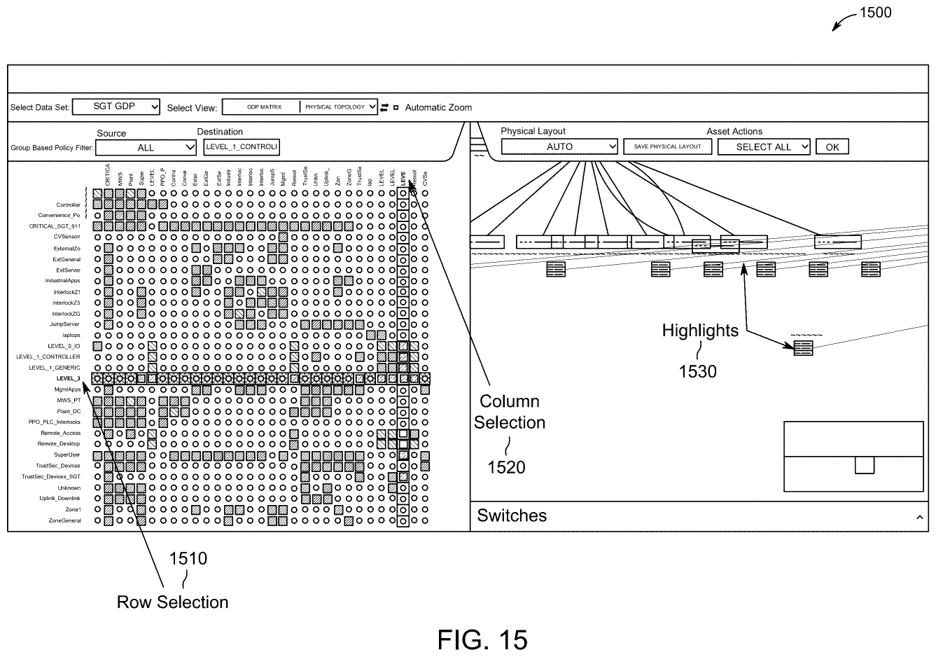

Further, FIG. 15 illustrates a view 1500 where an SGT source row and destination column are selected (“row selection 1510” and “column selection 1520”), highlighting all the physical connections between the two logical/security groups (“highlights 1530”). By visualizing the connections between these groups, administrators can see how the policy defined in the selected matrix cell is applied in the physical network. This helps understand the policy's impact on network traffic flow between the two security groups. If there's a connectivity issue or a security incident, the visual representation makes it easier to identify the affected parts of the network and facilitates quicker resolution.

Additionally, in accordance with another specific implementation herein, the dual panel visual mapping of logical and physical network topologies herein, may provide organizational tree (“Org-Tree”) based visualization.

Org-Tree based visualization through the techniques herein is designed to accommodate complex organizational structures and operational technology (OT) environments. It can provide a comprehensive view that integrates logical and physical network topologies and real-time based on role-based access control (RBAC) and location-specific information. This ensures network administrators and operators see only the parts of the network that they have the rights to access and manage. This is crucial for maintaining security and operational integrity, especially in sensitive OT environments.

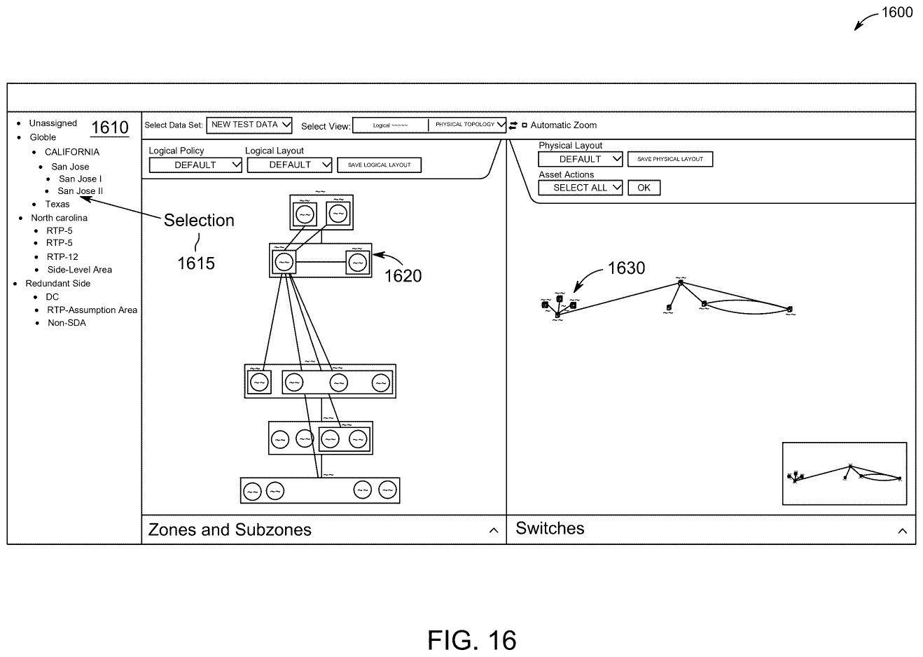

In OT networks, for instance, the logical topology often extends across multiple physical locations, such as different plants or operational sites. The techniques herein allow for the visualization of these cross-location logical topologies, helping administrators understand how different sites are interconnected on a logical level. For instance, as shown in view 1600 of FIG. 16, a locational org-tree 1610 demonstrates how selections may be made for logical correlations based on locations (e.g., “selection 1615” for “San Jose 2”) to determine policies 1620 and devices/assets 1630 associated therewith, according to one or more aspects of the present disclosure as described herein.

OT networks are typically structured around specific process control definitions that dictate how systems operate and interact. The techniques herein thus enable administrators to filter the network visualization based on these definitions, allowing for a focused view that aligns with operational requirements and processes.

The Org-Tree visualization implementation herein can thus be customized to reflect the unique hierarchies and dependencies within OT environments. This might include viewing devices by their logical asset groups or zones in the process control system, such as sensors, actuators, controllers, and other critical infrastructure components. Locations, as used above, is merely one example of how an organization tree structure may be configured in accordance with the techniques herein.

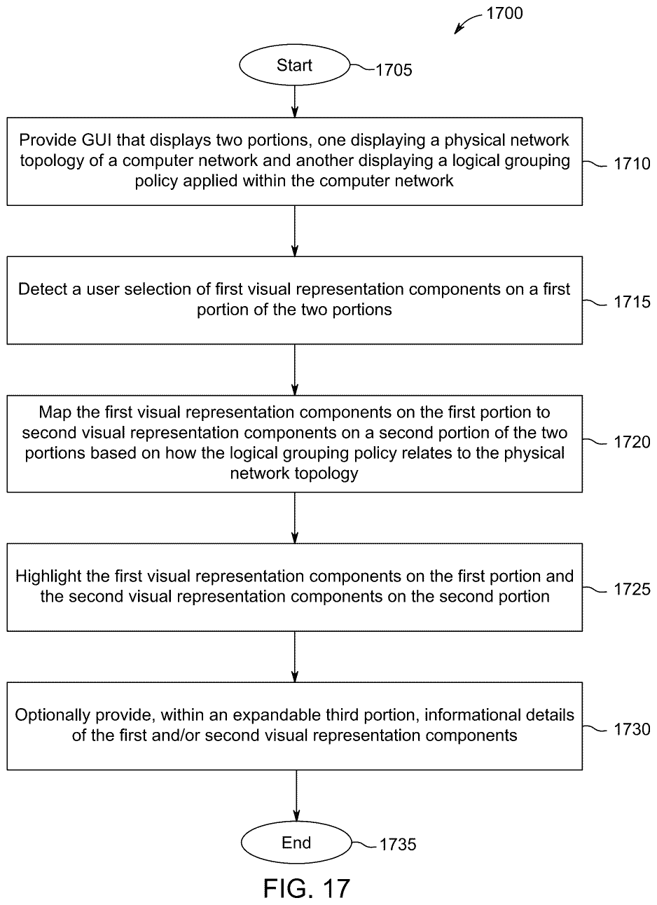

In closing, FIG. 17 illustrates an example simplified procedure for dual panel visual mapping of logical and physical network topologies in accordance with one or more embodiments described herein. For example, a non-generic, specifically configured device (e.g., device 200, an apparatus) may perform procedure 1700 by executing stored instructions (e.g., process 248, such as a “visualization process”). The procedure 1700 may start at step 1705, and continues to step 1710, where, as described in greater detail above, the process provides a graphical user interface (GUI) that displays two portions, one of the two portions displaying a physical network topology of a computer network and another of the two portions displaying a logical grouping policy applied within the computer network. (In one embodiment, the logical grouping policy comprises a group-based policy matrix, as noted above.)

Notably, in one embodiment, the process to provide the GUI may involve discovering at least a portion of the physical network topology through one or more device discovery protocols and/or determining at least a portion of the physical network topology from user-configured information configured on the graphical user interface. Moreover, in one embodiment, the process to provide the GUI may involve determining at least a portion of the logical grouping policy from configuration information obtained from one or more devices within the physical network topology and/or determining at least a portion of the logical grouping policy from user-configured information configured on the graphical user interface.

Moreover, in one embodiment, the process herein further comprises providing, via the graphical user interface, selectable subsets of the physical network topology to be displayed; and changing display of the logical grouping policy based on a particular selected subset of the physical network topology. In another embodiment, the process herein further comprises providing, via the graphical user interface, selectable logical policies of the logical grouping policy to be displayed; and changing display of the logical grouping policy based on a particular selected logical policy while the physical network topology to be displayed is maintained.

In step 1715, the process detects a user selection of one or more first visual representation components on a first portion of the two portions. As noted above, this may be from either portion of the GUI. That is, in one instance, the first portion corresponds to the logical grouping policy and the one or more first visual representation components are selected from a group consisting of: groups, zones, and sub-zones; and the second portion corresponds to the physical network topology and the one or more second visual representation components are selected from a group consisting of: devices, links, and assets. In another instance, the second portion corresponds to the logical grouping policy and the one or more second visual representation components are selected from a group consisting of: groups, zones, and sub-zones; and the first portion corresponds to the physical network topology and the one or more first visual representation components are selected from a group consisting of: devices, links, and assets.

In step 1720, the process may then map the one or more first visual representation components on the first portion to one or more second visual representation components on a second portion of the two portions based on how the logical grouping policy relates to the physical network topology, as described in greater detail above. Note that in one embodiment, the process herein comprises: detecting a first selection of one or more components of the physical network topology within the graphical user interface; detecting a second selection of one or more components of the logical grouping policy within the graphical user interface; and receiving instructions to assign mapping of the one or more components of the physical network topology to the one or more components of the logical grouping policy.

In step 1725, the process may then highlight, on the graphical user interface in response to the user selection, the one or more first visual representation components on the first portion and the one or more second visual representation components on the second portion.

In step 1730, the process may optionally provide, within an expandable third portion displayed within the graphical user interface, informational details of the one or more first visual representation components, the one or more second visual representation components, or both the one or more first visual representation components and the one or more second visual representation components.

Procedure 1700 may end at step 1735, notably with the option to continue receiving user selections on either side/portion of the dual-panel GUI. Specifically, for instance, bi-directionality in the procedure 1700 may be based on: detecting a new user selection of one or more third visual representation components on the second portion; unhighlighting, in response to the new user selection, the one or more first visual representation components on the first portion and the one or more second visual representation components on the second portion; mapping the one or more third visual representation components on the second portion to one or more fourth visual representation components on the first portion; and highlighting, on the graphical user interface in response to the new user selection, the one or more third visual representation components on the second portion and the one or more fourth visual representation components on the first portion.

It should be noted that while certain steps within the procedures above may be optional as described above, the steps shown in the procedures above are merely examples for illustration, and certain other steps may be included or excluded as desired. For instance, as described above, in one embodiment the procedure may further comprise: displaying, on the graphical user interface, a third portion that presents an organizational tree structure; detecting a particular user selection of one or more components on the organizational tree structure; mapping the one or more components on the organizational tree structure to one or more third visual representation components on the first portion and to one or more fourth visual representation components on the second portion based on how the organizational tree structure relates to the logical grouping policy and to the physical network topology; and highlighting, on the graphical user interface in response to the particular user selection, the one or more third visual representation components on the first portion and the one or more fourth visual representation components on the second portion.

Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: providing a graphical user interface that displays two portions, one of the two portions displaying a physical network topology of a computer network and another of the two portions displaying a logical grouping policy applied within the computer network; detecting a user selection of one or more first visual representation components on a first portion of the two portions; mapping the one or more first visual representation components on the first portion to one or more second visual representation components on a second portion of the two portions based on how the logical grouping policy relates to the physical network topology; and highlighting, on the graphical user interface in response to the user selection, the one or more first visual representation components on the first portion and the one or more second visual representation components on the second portion.

In still other implementations, a tangible, non-transitory, computer-readable medium storing program instructions that cause a device to execute a process comprising: providing a graphical user interface that displays two portions, one of the two portions displaying a physical network topology of a computer network and another of the two portions displaying a logical grouping policy applied within the computer network; detecting a user selection of one or more first visual representation components on a first portion of the two portions; mapping the one or more first visual representation components on the first portion to one or more second visual representation components on a second portion of the two portions based on how the logical grouping policy relates to the physical network topology; and highlighting, on the graphical user interface in response to the user selection, the one or more first visual representation components on the first portion and the one or more second visual representation components on the second portion.

The techniques described herein, therefore, provide for dual panel visual mapping of logical and physical network topologies. As mentioned, many other network visualization tools exist for either physical network topologies or logical network topologies, and a limited number of existing tools show both. For instance, graphical user interfaces exist in many forms to present physical network topologies, logical network topologies (e.g., for application flows, etc.), and information correlating the two and/or relating to the entities themselves (e.g., health, addresses, names, device types, and so on). Overlay-based GUIs exist to present various logical overlays on top of a physical topology. Most current network visualization systems today, though, are related to correlations between logical elements and associated physical elements, and are mostly concerned with virtual machines, logical routers/switches, and so on, which indeed create a “logical topology”. However, these are different from logical “policies” (or “logical grouping policy”), and no other system provides a user with a view that correlates logical policies to associated physical network assets, and vice versa as is accomplished by the techniques herein. That is, the techniques herein provide fundamentally different mappings (than physical network-to- logical grouping policies), and no known systems provide a side-by-side bi-directionally highlighting graphical user interface based on such mappings in the manner described herein.

Illustratively, the techniques described herein may be performed by hardware, software, and/or firmware, (e.g., an “apparatus”) such as in accordance with the network visualization process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
providing, by a visualization process, a graphical user interface that displays two portions, one of the two portions displaying a physical network topology of a computer network and another of the two portions displaying a logical grouping policy applied within the computer network;
detecting, by the visualization process, a user selection of one or more first visual representation components on a first portion of the two portions;
mapping, by the visualization process, the one or more first visual representation components on the first portion to one or more second visual representation components on a second portion of the two portions based on how the logical grouping policy relates to the physical network topology; and
highlighting, by the visualization process and on the graphical user interface in response to the user selection, the one or more first visual representation components on the first portion and the one or more second visual representation components on the second portion.

2. The method of claim 1, further comprising:
detecting a new user selection of one or more third visual representation components on the second portion;
unhighlighting, in response to the new user selection, the one or more first visual representation components on the first portion and the one or more second visual representation components on the second portion;
mapping the one or more third visual representation components on the second portion to one or more fourth visual representation components on the first portion; and
highlighting, on the graphical user interface in response to the new user selection, the one or more third visual representation components on the second portion and the one or more fourth visual representation components on the first portion.

3. The method of claim 1, wherein:
the first portion corresponds to the logical grouping policy and the one or more first visual representation components are selected from a group consisting of: groups, zones, and sub-zones; and
the second portion corresponds to the physical network topology and the one or more second visual representation components are selected from a group consisting of:
devices, links, and assets.

4. The method of claim 1, wherein:
the second portion corresponds to the logical grouping policy and the one or more second visual representation components are selected from a group consisting of: groups, zones, and sub-zones; and
the first portion corresponds to the physical network topology and the one or more first visual representation components are selected from a group consisting of: devices, links, and assets.

5. The method of claim 1, further comprising:
providing, within an expandable third portion displayed within the graphical user interface, informational details of the one or more first visual representation components, the one or more second visual representation components, or both the one or more first visual representation components and the one or more second visual representation components.

6. The method of claim 1, further comprising:
providing, via the graphical user interface, selectable subsets of the physical network topology to be displayed; and
changing display of the logical grouping policy based on a particular selected subset of the physical network topology.

7. The method of claim 1, further comprising:
providing, via the graphical user interface, selectable logical policies of the logical grouping policy to be displayed; and
changing display of the logical grouping policy based on a particular selected logical policy while the physical network topology to be displayed is maintained.

8. The method of claim 1, further comprising:
detecting a first selection of one or more components of the physical network topology within the graphical user interface;
detecting a second selection of one or more components of the logical grouping policy within the graphical user interface; and
receiving instructions to assign mapping of the one or more components of the physical network topology to the one or more components of the logical grouping policy.

9. The method of claim 1, further comprising:
discovering at least a portion of the physical network topology through one or more device discovery protocols.

10. The method of claim 1, further comprising:
determining at least a portion of the physical network topology from user-configured information configured on the graphical user interface.

11. The method of claim 1, further comprising:
determining at least a portion of the logical grouping policy from configuration information obtained from one or more devices within the physical network topology.

12. The method of claim 1, further comprising:
determining at least a portion of the logical grouping policy from user-configured information configured on the graphical user interface.

13. The method of claim 1, wherein the logical grouping policy comprises a group-based policy matrix.

14. The method of claim 1, further comprising:
displaying, on the graphical user interface, a third portion that presents an organizational tree structure;
detecting a particular user selection of one or more components on the organizational tree structure;
mapping the one or more components on the organizational tree structure to one or more third visual representation components on the first portion and to one or more fourth visual representation components on the second portion based on how the organizational tree structure relates to the logical grouping policy and to the physical network topology; and
highlighting, on the graphical user interface in response to the particular user selection, the one or more third visual representation components on the first portion and the one or more fourth visual representation components on the second portion.

15. A tangible, non-transitory, computer-readable medium storing program instructions that cause a device to execute a process comprising:
providing a graphical user interface that displays two portions, one of the two portions displaying a physical network topology of a computer network and another of the two portions displaying a logical grouping policy applied within the computer network;
detecting a user selection of one or more first visual representation components on a first portion of the two portions;
mapping the one or more first visual representation components on the first portion to one or more second visual representation components on a second portion of the two portions based on how the logical grouping policy relates to the physical network topology; and
highlighting, on the graphical user interface in response to the user selection, the one or more first visual representation components on the first portion and the one or more second visual representation components on the second portion.

16. The tangible, non-transitory, computer-readable medium of claim 15, wherein the process further comprises:
detecting a new user selection of one or more third visual representation components on the second portion;
unhighlighting, in response to the new user selection, the one or more first visual representation components on the first portion and the one or more second visual representation components on the second portion;
mapping the one or more third visual representation components on the second portion to one or more fourth visual representation components on the first portion; and
highlighting, on the graphical user interface in response to the new user selection, the one or more third visual representation components on the second portion and the one or more fourth visual representation components on the first portion.

17. The tangible, non-transitory, computer-readable medium of claim 15, wherein the process further comprises:
providing, via the graphical user interface, selectable subsets of the physical network topology to be displayed; and
changing display of the logical grouping policy based on a particular selected subset of the physical network topology.

18. The tangible, non-transitory, computer-readable medium of claim 15, wherein the process further comprises:
detecting a first selection of one or more components of the physical network topology within the graphical user interface;
detecting a second selection of one or more components of the logical grouping policy within the graphical user interface; and
receiving instructions to assign mapping of the one or more components of the physical network topology to the one or more components of the logical grouping policy.

19. The tangible, non-transitory, computer-readable medium of claim 15, wherein the logical grouping policy comprises a group-based policy matrix.

20. An apparatus, comprising:
one or more network interfaces to communicate with a network;
a processor coupled to the one or more network interfaces and configured to execute one or more processes; and
a memory configured to store a process that is executable by the processor, the process comprising:
providing a graphical user interface that displays two portions, one of the two portions displaying a physical network topology of a computer network and another of the two portions displaying a logical grouping policy applied within the computer network;
detecting a user selection of one or more first visual representation components on a first portion of the two portions;
mapping the one or more first visual representation components on the first portion to one or more second visual representation components on a second portion of the two portions based on how the logical grouping policy relates to the physical network topology; and
highlighting, on the graphical user interface in response to the user selection, the one or more first visual representation components on the first portion and the one or more second visual representation components on the second portion.
